(19) United States
(12) Patent Application Publication
(10) Pub. No.: US 2008/0163651 A1
(43) Pub. Date: Jul. 10, 2008

(54) Multiple laundry treating apparatus

(75) Inventors: Seong Hae Jeong, Changwon-si (KR); Seong Jin Jo, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/007,390

(22) Filed: Jan. 9, 2008

(30) Foreign Application Priority Data
Jan. 10, 2007 (KR) 10-2007-0002806

(51) Int. Cl. B08B 3/12

(52) U.S. Cl. 68/5 C

(57) ABSTRACT

The present invention relates to a multiple laundry treating apparatus. The multiple laundry treating apparatus includes a laundry machine body, an auxiliary body mounted at one side of the laundry machine body, the auxiliary body having a volume and height less than that of the laundry machine body, the auxiliary body being provided with a laundry receiving space, and an air supply unit for forcibly supplying air into the auxiliary body, wherein at least some components of the air supply unit are mounted in the laundry machine body.

### CROSS-REFERENCE TO RELATED APPLICATION

This application claims the benefit of Korean Patent Application No. 10-2007-0002806, filed on Jan. 10, 2007, which is hereby incorporated by reference in its entirety as if fully set forth herein.

### BACKGROUND OF THE INVENTION

1. Field of the Invention

The present invention relates to a multiple laundry treating apparatus and a control method thereof, and more particularly, to a multiple laundry treating apparatus including a main laundry treating machine and an auxiliary laundry treating machine coupled to the main laundry treating machine.

2. Discussion of the Related Art

Generally, laundry treating apparatuses are apparatuses that are capable of washing and/or drying laundry. Specifically, the respective laundry treating apparatuses perform a washing operation, a drying operation, or a washing-and-drying operation. Recently, there has been increasingly used a laundry treating apparatus, including a steam supply unit, that is capable of performing a refreshing operation to remove wrinkles, smells, and static electricity from laundry.

FIG. 1 is a perspective view illustrating a conventional laundry treating apparatus 1.

As shown in FIG. 1, the conventional laundry treating apparatus 1 includes a main body 10 forming the external appearance of the laundry treating apparatus and a control panel 11 mounted at the front or the top of the main body 10. Here, the control panel 11 may include a control unit for controlling the operation of the laundry treating apparatus. Consequently, it is possible for a user to manipulate the control panel 11 such that the laundry treating apparatus performs a laundry treating operation, such as washing or drying.

Here, the laundry treating apparatus may be a washing machine, a drying machine, or a washing-and-drying machine.

On the other hand, the conventional laundry treating apparatus may further include a base 20 for supporting the main body 10 on the floor. The main body 10 is mounted on the base 20.

Generally, the base 20 has a predetermined space defined therein. The space may be constructed in the form of a drawer 21 that can be withdrawn outward from the front of the base. In addition to the function for supporting the main body 10, the base 20 serves as a storage box for storing detergent or laundry.

However, the conventional base 20 does not perform any function for laundry treatment. In other words, the conventional base 20 is utilized only to support the main body 10. Consequently, there is a high necessity for a base 20 that has a laundry treating function as well as a main body supporting function in a spatial utilization aspect or in a washing efficiency aspect.

Meanwhile, the size of the conventional laundry treating apparatus having a drying function, such as the drying machine and the washing-and-drying machine, has been gradually increased. As a result, the large-sized laundry treating apparatus is operated to dry a relatively small amount of laundry, which is disadvantageous in an energy saving aspect.

For a drum type laundry treating apparatus, on the other hand, it is difficult to dry shoes or clothes. Of course, it is possible to mount a rack, on which shoes are located, in the drum, such that the level of the rack is maintained irrespective of the rotation of the drum, to dry the shoes in the drum. In this case, however, it is required for a user to mount and remove the rack in and from the drum when needed, which is very troublesome.

### SUMMARY OF THE INVENTION

Accordingly, the present invention is directed to a multiple laundry treating apparatus that substantially obviates one or more problems due to limitations and disadvantages of the related art.

An object of the present invention is to provide a multiple laundry treating apparatus that is capable of treating a small amount of laundry without operating a relatively large-sized laundry treating apparatus, thereby improving convenience of use and saving energy.

Another object of the present invention is to provide a multiple laundry treating apparatus that is capable of easily drying laundry, such as shoes or hats, which are difficult to be dried by a conventional drum type drying machine or washing-and-drying machine.

A further object of the present invention is to provide a multiple laundry treating apparatus that is capable of utilizing an auxiliary space, such as a base, of a conventional laundry treating apparatus as an auxiliary laundry treating apparatus, and, especially, drying laundry in the auxiliary space.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a multiple laundry treating apparatus includes a laundry machine body, an auxiliary body mounted at one side of the laundry machine body, the auxiliary body having a volume and height less than that of the laundry machine body, the auxiliary body being provided with a laundry receiving space, and an air supply unit for forcibly supplying air into the auxiliary body, wherein at least some components of the air supply unit are mounted in the laundry machine body.

Preferably, the multiple laundry treating apparatus further includes a coupling unit for coupling the auxiliary body to the one side of the laundry machine body.

Preferably, the air supply unit includes a blowing fan for blowing air, a heater for heating the air blown by the blowing fan, and a connection channel connected between the laundry machine body and the auxiliary body for guiding the air to the auxiliary body.

Preferably, the blowing fan and/or the heater is mounted in the laundry machine body.

Preferably, the auxiliary body is provided with an inlet port connected to the connection channel for allowing heated air to be introduced therethrough and an outlet port for allowing the air to be discharged from the laundry receiving space therethrough.

Preferably, the heater is mounted in the laundry machine body, and the blowing fan is mounted in the auxiliary body adjacent to the outlet port.

Preferably, the heater is mounted in the connection channel extending into the laundry machine body.

Preferably, the blowing fan is mounted in the laundry machine body, and the heater is mounted in the auxiliary body adjacent to the inlet port.

Preferably, the blowing fan is mounted in the connection channel extending into the laundry machine body.

Preferably, the blowing fan and the heater are mounted in the laundry machine body.

Preferably, the blowing fan and the heater are mounted in the connection channel extending into the laundry machine body.

Preferably, the laundry receiving space is constructed in the form of a drawer that can be withdrawn outward from the front of the auxiliary body.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a conventional laundry treating apparatus;

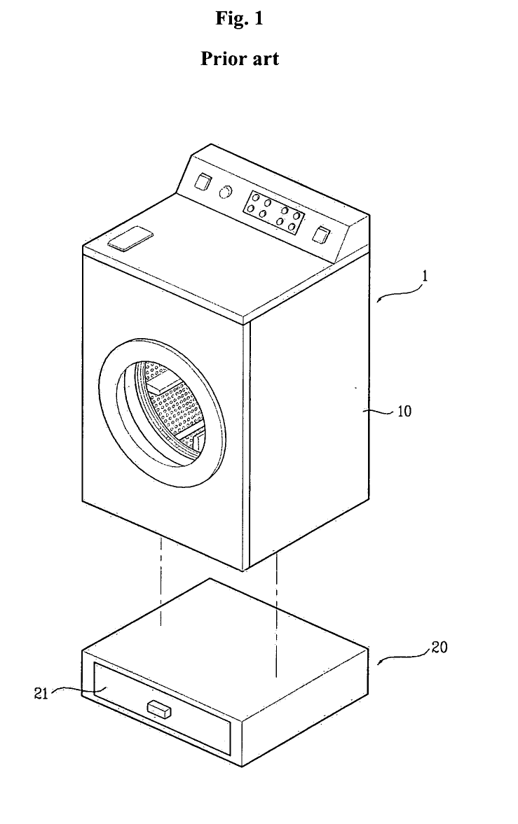

FIG. 2 is a perspective view illustrating a multiple laundry treating apparatus according to an embodiment of the present invention;

FIG. 3 is an exploded perspective view illustrating a coupling unit for coupling an auxiliary body to a laundry machine body of FIG. 2;

FIG. 4 is a side view illustrating a multiple laundry treating apparatus including an auxiliary body according to an embodiment of the present invention;

FIG. 5 is a side view illustrating a multiple laundry treating apparatus including an auxiliary body according to another embodiment of the present invention; and

FIG. 6 is a side view illustrating a multiple laundry treating apparatus including an auxiliary body according to a further embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. In the present invention, meanwhile, a laundry machine body may be a drying machine having a general drying function, a washing machine, or a washing-and-drying machine. Of course, most of the components mounted in the laundry machine body may be identical to those of the drying machine, the washing machine, or the washing-and-drying machine. Consequently, a detailed description of the components of the laundry machine body which are identical to those of the drying machine, the washing machine, or the washing-and-drying machine will not be given.

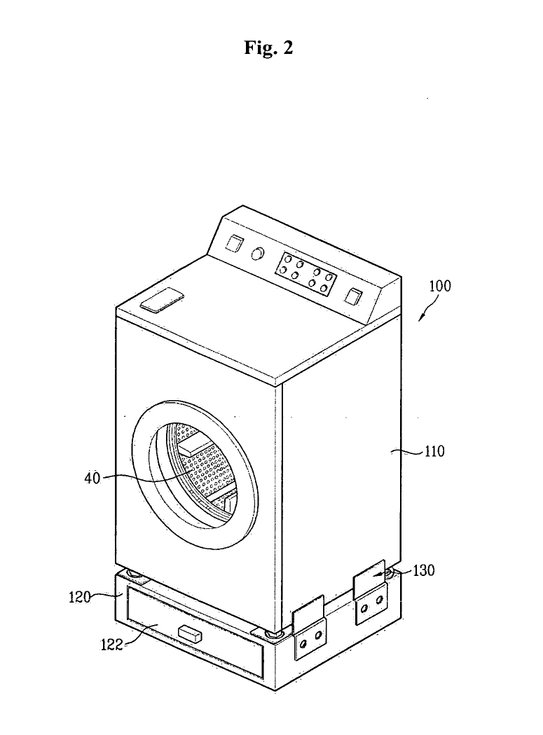

FIG. 2 is a perspective view illustrating a multiple laundry treating apparatus 100 according to an embodiment of the present invention.

Referring to FIG. 2, the multiple laundry treating apparatus according to the present invention has the same external appearance as that of the conventional drying machine equipped with the base 20. In this embodiment, however, a base of the multiple laundry treating apparatus according to the present invention performs an auxiliary laundry treating function as well as the conventional supporting function, as shown in FIG. 2, which is distinguished from the conventional art. In addition, the multiple laundry treating apparatus according to the present invention further includes a coupling unit 130 for stably coupling the auxiliary laundry treating apparatus to the main laundry treating apparatus, which is also distinguished from the conventional art. Consequently, the multiple laundry treating apparatus according to the present invention is capable of performing an auxiliary laundry treating function as well as a function of a general drying machine.

As shown in FIG. 2, the multiple laundry treating apparatus according to the present invention includes a laundry machine body 110 and an auxiliary body 120 mounted at one side of the laundry machine body 110. In the auxiliary body 120 is mounted a drawer 122 that receives laundry and is constructed to be withdrawn outward from the front of the auxiliary body 120. On the other hand, a laundry receiving part, for example, a drum 40, is mounted in the laundry machine body 110.

The auxiliary body 120 may be mounted at the bottom of the laundry machine body 110 or at the top of the laundry machine body 110. Alternatively, the auxiliary body 120 may be mounted at the side of the laundry machine body 110. Preferably, however, the auxiliary body 120 is mounted at the top or bottom of the laundry machine body 110 in consideration of a spatial utilization aspect or a design aspect.

Hereinafter, the coupling unit 130, which couples the auxiliary body 120 to the laundry machine body 110, will be described in detail with reference to the accompanying drawings, and then a detailed description of the auxiliary laundry treating apparatus will be given.

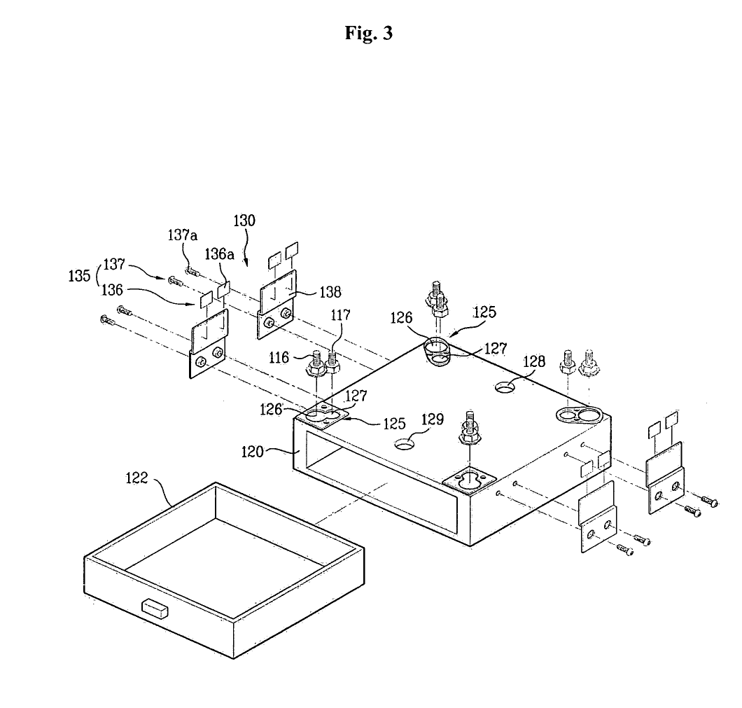

FIG. 3 is an exploded perspective view illustrating the coupling unit 130, which serves to couple the auxiliary body 120 to the laundry machine body 110, according to the present invention.

Referring to FIG. 3, the multiple laundry treating apparatus according to the present invention includes leg supporters 125 mounted at the top of the auxiliary body 120 for supporting lower legs 116 and 117 of the clothes dryer 100.

Each leg supporter 125 includes a panel having a first fitting hole 126, in which the corresponding leg 116 for a washing-and-drying machine is fitted, and a second fitting hole 127, in which the corresponding leg 117 for a drying machine is fitted. The respective leg supporters 125 are fixed to the top of the auxiliary body 120 by screws. Here, the washing-and-drying machine and the drying machine are specific examples of the laundry treating machines, the drawing illustrates that the size of the washing-and-drying machine is greater than that of the drying machine.

The leg supporters 125 are fixed to the top of the auxiliary body 120 at the respective corners of the auxiliary body 120. The first fitting holes 126 and the second fitting holes 127 formed in the two leg supporters 125 fixed to the front corners of the auxiliary body 120 are connected to each other. On the other hand, the first fitting holes 126 and the second fitting holes 127 formed in the two leg supporters 125 fixed to the rear corners of the auxiliary body 120 are separated from each other. This is to accomplish easy and convenient fitting of the legs 116 for the washing-and-drying machine in the corresponding fitting holes of the leg supporters 125.

Also, the first fitting holes 126 are positioned outside the corresponding second fitting holes 127 on diagonal lines at the bottom of the laundry machine body 110. This is because the size of the washing-and-drying machine is generally greater than that of the drying machine.

Meanwhile, the coupling unit 130 according to the present invention includes a plurality of coupling members 138 mounted to the side of the washing-and-drying machine or the drying machine and to the side of the auxiliary body 120 located below the washing-and-drying machine or the drying machine, and a plurality of fixing members 135 for fixing the coupling members 138 to the side of the washing-and-drying machine or the drying machine and to the side of the auxiliary body 120.

As shown in FIG. 3, the coupling members 138 may be provided such that two coupling members 138 fix the auxiliary body 120 and the laundry machine body 110 to each other at each lateral side of the auxiliary body 120 and the laundry machine body 110, especially at the interface between the auxiliary body 120, which is constructed in a hexahedral shape, and the laundry machine body 110, which is constructed in a hexahedral shape. In addition, additional third coupling members (not shown) may be mounted to the rear of the auxiliary body 120 and the laundry machine body 110 for fixing the auxiliary body 120 and the laundry machine body 110 to each other.

Here, the coupling unit 130 may be modified depending upon the change in height of the legs 116 for the washing-and-drying machine or the legs 117 for the drying machine.

Meanwhile, each fixing member 135 includes a first fixing member 136 for fixing the upper part of the corresponding coupling member 138 to the lower part of the washing-and-drying machine or the drying machine at each lateral side of the washing-and-drying machine or the drying machine, and a second fixing member 137 for fixing the lower part of the corresponding coupling member 138 to the upper part of the auxiliary body 120 at each lateral side of the auxiliary body 120.

Here, the first fixing member 136 and/or the second fixing member 137 may be an adhesive member having an adhesive material applied to opposite major surfaces thereof, for example, a double-sided adhesive tape. On the other hand, the first fixing member 136 and/or the second fixing member 137 may be a connection member, such as a screw. When the fixing member is the screw as described above, connection holes are preferably formed at the corresponding coupling member while the connection holes are spaced a predetermined distance from each other.

Unlike the above description, on the other hand, the means for accomplishing the coupling between the laundry machine body 110 and the auxiliary body 120 may be modified in various forms.

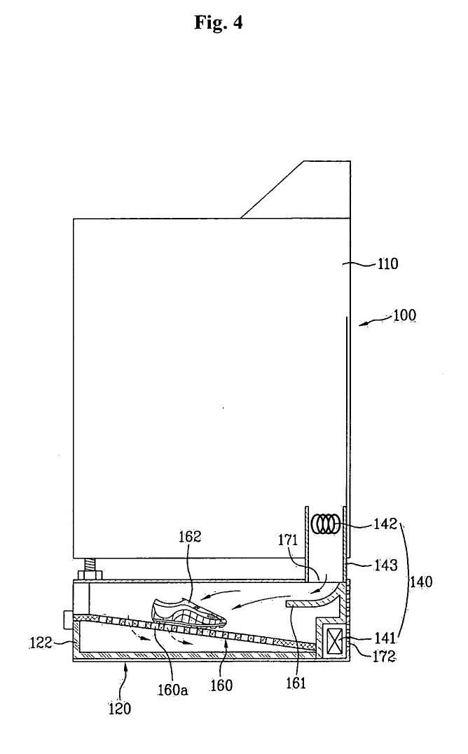

Hereinafter, various embodiments of the auxiliary body according to the present invention will be described in detail with reference to FIGS. 4 to 6.

In this case, the multiple laundry treating apparatus according to the present invention is preferably constructed in a structure in which a blowing fan and/or a heater, among components constituting an air supply unit for supplying air to the auxiliary body, is mounted in the laundry machine body to increase the laundry receiving space of the auxiliary body. With the above-described structure, the laundry receiving space is increased, and therefore, it is possible to treat a relatively large amount of laundry, as compared to when the blowing fan and the heater are mounted in the auxiliary body.

FIG. 4 illustrates a multiple laundry treating apparatus 100 constructed in a structure in which a component of an air supply unit 140 for supplying air to the interior space of the auxiliary body 120, i.e., a heater 142, is mounted in the laundry machine body 110, and another component of the air supply unit 140, i.e., a blowing fan 141, is mounted in the auxiliary body 120.

Referring to FIG. 4, the auxiliary body 120 according to this embodiment is coupled to the laundry machine body 110 to constitute the multiple laundry treating apparatus 100. In this case, laundry is received in the laundry machine body 110 such that the laundry is washed or dried.

The multiple laundry treating apparatus 100 includes a coupling unit for coupling the auxiliary body 120 to one side of the laundry machine body 110. For convenience of description, the coupling unit is not illustrated in FIG. 4.

The auxiliary body 120 has a laundry receiving space defined therein for performing an auxiliary laundry treating function. The laundry receiving space may be constructed in the form of a drawer that can be withdrawn outward from the front of the auxiliary body 120.

The air supply unit 140, which supplies air into the auxiliary body 120, includes a heater 142 for heating air, a blowing fan 141 for blowing air, and a connection channel 143 connected between the laundry machine body 110 and the auxiliary body 120.

The heater 142 is mounted in the laundry machine body 110. Specifically, the heater 142 is preferably located in the connection channel 143 extending into the laundry machine body 110. The connection channel 143 is connected to an inlet port 171, formed at the auxiliary body 120, for guiding air into the auxiliary body 120. The blowing fan 141 is located adjacent to an outlet port 172 of the auxiliary body 120. Consequently, when the blowing fan 141 is driven, external air is introduced into the auxiliary body 120 through the laundry machine body 110 and the connection channel 143, and is then discharged outside the auxiliary body 120. The external air is heated by the heater 142, mounted in the laundry machine body 110, before the external air is introduced into the auxiliary body 120 through the connection channel 143. Consequently, it is natural that the external air introduced into the auxiliary body 120 is heated air.

However, the present invention is not limited to this embodiment. For example, the heater 142 may be located at any position in the laundry machine body 110 so long as heated air is supplied into the auxiliary body 120 through the connection channel 143. Also, the blowing fan 141 may be located at any position in the auxiliary body 120 so long as air is discharged from the auxiliary body 120.

As shown in FIG. 4, meanwhile, laundry 162 is put in the drawer 122. The inner space of the drawer 122 is divided into upper and lower spaces. In the drawer 122 is mounted a shelf 160 for allowing the upper and lower spaces to communicate with each other. The shelf 160 is provided to smoothly supply heated air to the laundry 162 and to discharge the supplied air out of the drawer 122.

Preferably, the shelf 160 is provided with a plurality of through-holes 160a. Consequently, air, introduced into the drawer 122 through the inlet port 171, flows from the upper space of the drawer 122 to the lower space of the drawer 122, and is then discharged out of the drawer 122 through the outlet port 172.

Also, the shelf 160 may be mounted in an inclined fashion. In this case, it is preferable for the shelf 160 to be inclined downward toward the inlet port 171, through which the heated air is introduced. As a result, the heated air is uniformly supplied to the laundry placed on the shelf 160.

Preferably, the drawer 122 is provided at the rear wall thereof with an air guide 161. The air guide 161 serves to guide air such that the heated air can be supplied toward the laundry in the drawer 122, and, at the same time, to divide the air introduction channel and the air discharge channel from each other. Consequently, the collision between the introduced air and the discharged air is minimized by the provision of the air guide 161, and therefore, the laundry drying efficiency is improved.

Hereinafter, the operation of the multiple laundry treating apparatus including the auxiliary body with the above-stated construction will be described.

First, when small-sized laundry articles, such as shoes, are to be treated, for example, dried, a user places the small-sized laundry articles on the shelf 160 in the drawer 122.

Subsequently, the user manipulates a control panel to control the operation of the auxiliary body. The control panel may be mounted in the laundry machine body for controlling the operation of the auxiliary body. Alternatively, the control panel may be mounted in the auxiliary body.

With the manipulation of the control panel, the auxiliary body is operated, and therefore, the heater 142 and the blowing fan 172 are driven. When the blowing fan 172 is driven, air is introduced from the laundry machine body 110 into the auxiliary body 120 through the connection channel 143. When the air flows through the connection channel 143, the air is heated by the heater 142, with the result that the heated air is introduced into the auxiliary body 120.

The heated air, introduced into the auxiliary body 120, flows toward small-sized laundry articles by the air guide 161. The air, used to dry the small-sized laundry articles, flows to the lower space of the auxiliary body 120, below the shelf 160, through the through-holes 160a of the shelf 160, and is then discharged out of the auxiliary body 120 through the outlet port 172.

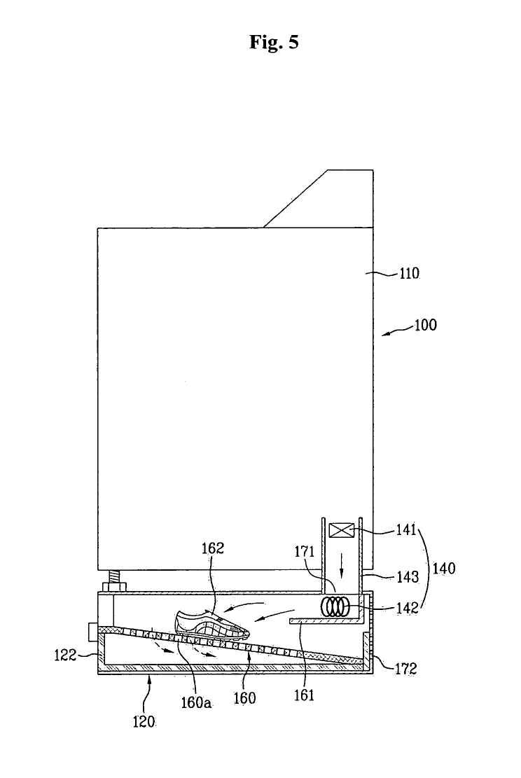

FIG. 5 is a side view illustrating a multiple laundry treating apparatus including an auxiliary body according to another embodiment of the present invention.

This embodiment is different from the previous embodiment in that the blowing fan 141 is mounted in the laundry machine body 110, and the heater 142 is mounted in the auxiliary body 120. Hereinafter, the multiple laundry treating apparatus including the auxiliary body according to this embodiment will be described based on the difference between this embodiment and the previous embodiment.

Referring to FIG. 5, the blowing fan 141 is mounted in the laundry machine body 110. Preferably, the blowing fan 141 is located in the connection channel 143 extending into the laundry machine body 110. Consequently, the blowing fan 141 serves to introduce air from the laundry machine body 110 into the auxiliary body 120. The heater 142 is located in the auxiliary body 142 adjacent to the inlet port 171 for heating the air introduced into the auxiliary body 120 by the blowing fan 141. Preferably, the heater 142 is located between the air guide 161 and the inlet port 171 for heating the air introduced through the connection channel 143.

When the blowing fan 141 is operated, external air is introduced into the auxiliary body 120 through the connection channel 143. The introduced air is heated by the heater 142 such that the laundry 162 can be dried by the heated air. The wet air, used to dry the laundry 162, is discharged out of the auxiliary body 120 through the outlet port 172.

Meanwhile, the other components of the auxiliary body according to this embodiment, such as the shelf 160 and the drawer 122, are identical or similar to those of the previous embodiment, and therefore, a detailed description thereof will not be given.

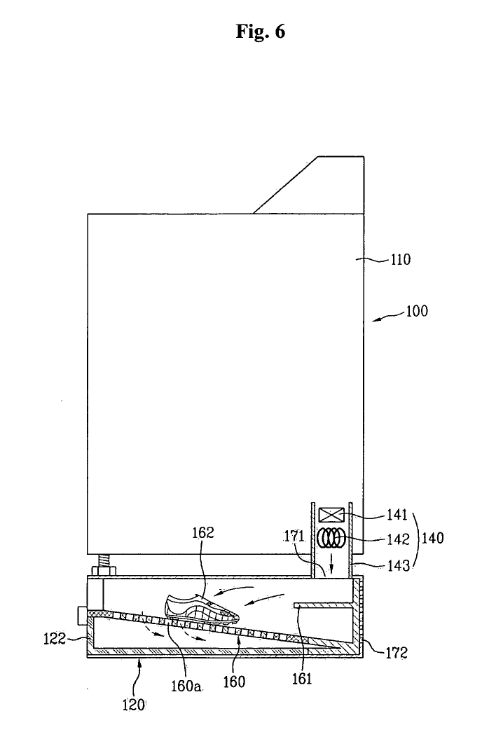

FIG. 6 is a side view illustrating a multiple laundry treating apparatus including an auxiliary body according to a further embodiment of the present invention.

This embodiment is different from the previous embodiments in that both the blowing fan 141 and the heater 142 are mounted in the laundry machine body 110. Hereinafter, the multiple laundry treating apparatus including the auxiliary body according to this embodiment will be described based on the difference between this embodiment and the previous embodiments.

Referring to FIG. 6, both the blowing fan 141 and the heater 142 are mounted in the laundry machine body 110. Preferably, the blowing fan 141 and the heater 142 are located in the connection channel 143 extending into the laundry machine body 110.

Consequently, when air is supplied from the laundry machine body 110 into the auxiliary body 120 with the operation of the blowing fan 141, the supplied air is heated by the heater 142. The heated air is introduced into the auxiliary body 120 through the connection channel 143 such that the laundry 162 can be dried by the heated air. The wet air, used to dry the laundry 162, is discharged out of the auxiliary body 120 through the outlet port 172.

However, the positions of the blowing fan 141 and the heater 142 are not particularly restricted so long as both the blowing fan 141 and the heater 142 are mounted in the laundry machine body 110 such that the heated air can be introduced into the auxiliary body.

Meanwhile, the other components of the auxiliary body according to this embodiment, such as the shelf 160 and the drawer 122, are identical or similar to those of the previous embodiments, and therefore, a detailed description thereof will not be given.

As apparent from the above description, the multiple laundry treating apparatus according to the present invention has the following effects.

The multiple laundry treating apparatus according to the present invention treats a small amount of laundry through the use of the auxiliary body without the operation of the relatively large-sized laundry machine body. Consequently, the present invention has the effect of improving convenience of use and saving energy.

Also, the multiple laundry treating apparatus according to the present invention easily dries laundry, such as shoes or hats, which are difficult to be dried by the conventional drum type drying machine. In addition, the auxiliary space, such as the base of the conventional laundry treating apparatus, is used as the auxiliary laundry treating apparatus according to the present invention.

Also, the multiple laundry treating apparatus according to the present invention is operated with low costs, and the spatial utilization of the multiple laundry treating apparatus is maximized. Consequently, the use of the multiple laundry treating apparatus is very convenient.

Furthermore, the multiple laundry treating apparatus according to the present invention is constructed in a structure in which the blowing fan and/or the heater, among the components of the air supply unit, which supplies air to the auxiliary body, is mounted in the laundry machine body. In this case, the laundry receiving space of the auxiliary body is increased as compared to that of the auxiliary body constructed in a structure in which both the blowing fan and the heater are mounted in the auxiliary body. Consequently, it is possible to dry a relatively large amount of laundry.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A multiple laundry treating apparatus comprising:
a laundry machine body;
an auxiliary body mounted at one side of the laundry machine body, the auxiliary body having a volume and height less than that of the laundry machine body, the auxiliary body being provided with a laundry receiving space; and
an air supply unit for supplying air into the auxiliary body, wherein at least some components of the air supply unit are mounted in the laundry machine body.

2. The multiple laundry treating apparatus according to claim 1, further comprising:
at least a coupling unit for coupling the auxiliary body to the one side of the laundry machine body.

3. The multiple laundry treating apparatus according to claim 1, wherein the air supply unit includes
a blowing fan for blowing air,
a heater for heating the air blown by the blowing fan, and
a connection channel connected between the laundry machine body and the auxiliary body for guiding the air to the auxiliary body.

4. The multiple laundry treating apparatus according to claim 3, wherein at least one of the blowing fan and the heater is mounted in the laundry machine body.

5. The multiple laundry treating apparatus according to claim 4, wherein the auxiliary body is provided with an inlet port connected to the connection channel for allowing heated air to be introduced therethrough and an outlet port for allowing the air to be discharged from the laundry receiving space therethrough.

6. The multiple laundry treating apparatus according to claim 5, wherein
the heater is mounted in the laundry machine body, and
the blowing fan is mounted in the auxiliary body adjacent to the outlet port.

7. The multiple laundry treating apparatus according to claim 6, wherein the heater is mounted in the connection channel extending into the laundry machine body.

8. The multiple laundry treating apparatus according to claim 7, wherein the auxiliary body is provided with an air guide for supplying the heated air toward a laundry in the auxiliary body.

9. The multiple laundry treating apparatus according to claim 8, wherein the air guide divides an air introduction channel and an air discharge channel from each other in the auxiliary body to minimize the collision between an introduced air and discharged air.

10. The multiple laundry treating apparatus according to claim 5, wherein
the blowing fan is mounted in the laundry machine body, and
the heater is mounted in the auxiliary body adjacent to the inlet port.

11. The multiple laundry treating apparatus according to claim 10, wherein the blowing fan is mounted in the connection channel extending into the laundry machine body.

12. The multiple laundry treating apparatus according to claim 11, wherein the auxiliary body is provided with an air guide for supplying the heated air toward a laundry in the auxiliary body.

13. The multiple laundry treating apparatus according to claim 12, wherein the air guide divides an air introduction channel and an air discharge channel from each other in the auxiliary body to minimize the collision between an introduced air and discharged air.

14. The multiple laundry treating apparatus according to claim 5, wherein the blowing fan and the heater are mounted in the laundry machine body.

15. The multiple laundry treating apparatus according to claim 14, wherein the blowing fan and the heater are mounted in the connection channel extending into the laundry machine body.

16. The multiple laundry treating apparatus according to claim 15, wherein the auxiliary body is provided with an air guide for supplying the heated air toward a laundry in the auxiliary body.

17. The multiple laundry treating apparatus according to claim 16, wherein the air guide divides an air introduction channel and an air discharge channel from each other in the auxiliary body to minimize the collision between an introduced air and discharged air.

18. The multiple laundry treating apparatus according to claim 1, wherein the laundry receiving space is constructed in the form of a drawer that can be withdrawn outward from the front of the auxiliary body.
